(19) United States
(12) Patent Application Publication
(10) Pub. No.: US 2004/0235484 A1
(43) Pub. Date: Nov. 25, 2004

(54) Expansion planning for wireless network

(76) Inventors: Harri Korpela, Espoo (FI); Jukka K. Nurminen, Espoo (FI); Hunor Demeter, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/487,044

(22) PCT Filed: Aug. 22, 2001
(86) PCT No.: PCT/EP01/09717

(51) Int. Cl. H04Q 7/20

(52) U.S. Cl. 455/446

(57) ABSTRACT

The present invention is directed to a method and system for planning an expansion of a constantly changing wireless network. Node parameters of networks nodes of the wireless network are stored in a database (109). The network is monitored by regularly reading node specific data stored at the network nodes, and the database (109) is constantly updated according to determined node changes. Based on the constantly updated node parameters a combined coverage area achieved by the network nodes is calculated. Thereby, the actual network coverage is available at any given point in time to plan network changes, to understand how good the coverage is in a particular area, and to make marketing and business decisions.

### FIELD OF THE INVENTION

The present invention relates to a method and system for planning an expansion of a dynamically or constantly changing wireless network, in particular an expansion of a wireless customer access network in which new wireless routers are added based on individual customer decisions.

### BACKGROUND OF THE INVENTION

In the last years the Internet has seen a rapid growth so that the Internet has become one of the single most important tools for communication. Along with the growth of the Internet the need for quick and ready access to the Internet from any location has increased. As a result access bandwidth demand has been growing at such a pace that the wired infrastructure can not keep up with. The upgrading of the wired infrastructure to provide high-speed and remote Internet access is costly complicated and time consuming, resulting in a bottleneck at the Internet access point the so-called last mile of Internet infrastructure.

Wireless broadband networks make high performance Internet access possible where wired broadband infrastructure is impractical. However, such a wireless broadband network will only be a success especially for residential and small business markets if the infrastructure is provided at a low-cost, is robust to changing environments and easy to deploy and scalable with market demand.

High-performance wireless connections require clear line-of-sight between links. In many environments or surroundings buildings, trees, hills and the curvature of the earth make line-of-sight difficult.

New wireless networks with wireless routers as network nodes on a mesh network basis emulate the topology and protocols of the Internet but are optimised for wireless high-speed data transmission. As an example of such a wireless broadband solution a wireless routing network has been developed. The key components of such a wireless routing network are a routed mesh network architecture, wireless routers, a wireless operating system and the deployment and management of the network.

Routed mesh networks mirror the structure of the wired Internet. Each radio transceiver at a node in the wireless network becomes part of the infrastructure and can route data through the wireless mesh network to its destination just as in the wired Internet. The advantage of such a routed mesh networks is that line-of-sight problems can be reduced in comparison to a client/base station architecture because each node only needs line-of-sight to one other node in the network and not all the way to the ultimate destination of the data traffic, e.g. the point-of-presence (POP). With such an infrastructure the reach and coverage of the wireless network is extended with a minimal amount of wireless network infrastructure and interconnection costs. The data traffic can be routed around obstructions rather than needing to deploy additional base stations for line-of-sight in densely populated diverse geographical locations. The more wireless routers are added to the network, the more robust and far-reaching the network becomes. In the above mentioned wireless routing network, wireless router with omni-directional antennas are used as a network node. Each wireless router can communicate with other nodes, i.e. other wireless routers in any direction. The omni-directional antennas offer a 360-degree range and do not require precise pointing or steering. Therefore additional wireless routers can be added in an ad hoc and incremental fashion.

The wireless routers substantially comprise three components, namely a full TCP/IP (Transmission Control Protocol/Internet Protocol) protocol suite support, a wireless operating system that optimises the wireless network performance and robustness, and a high-performance digital RF modem. A specialized wireless networking-software in combination with the high-performance RF modem optimise the network performance while insuring full IP support and robust and steamless IP routing.

Routed wireless mesh networks deploy specialized protocols, that operate efficiently in a multihop wireless network environment. From the media access control (MAC) layer through to the routing layer new protocols must be used that are specifically designed to deal with their unique attributes. The protocol suite extends the traditional TCP/IP stack to provide efficient and robust IP-based networking in multihop wireless mesh networks. These protocols consist of four parts, namely channel access protocols, reliable link and neighbour management protocols wireless multihop routing and multicast protocols and standard Internet protocols.

In the channel access, protocols are used to efficiently schedule transmissions to avoid collisions and efficiently reuse the available spectrum. Reliable link and neighbour management protocols ensure reliable transmissions on a hop-by-hop basis, and manage the automatic adaptation to changes in the network topology by monitoring the status of neighbour links. The role of the reliable link and neighbour management protocols is to perform network synchronisation and to manage the links to each neighbour node. Wireless multihop routing and multicast protocols maintain performance-optimised routing tables and enable an efficient multicast capability. The standard Internet protocols and tools for seamless integration with the wired Internet. The protocols and tools are for example TCP/IP, UDP (User Datagram Protocol), SNMP (Simple Network Management Protocol), RIP, ICMP (Internet Control Message Protocol), TFTP, ARP, IGMP, Proxy-ARP, DHCP relay (Dynamic Host Configuration Protocol), DHCP server, NAT (Network Address Translation).

Wireless mesh networks based on a multipoint-to-multipoint architecture make an ad hoc integration of new nodes, i.e. wireless routers, easier, since the actual demand and traffic flow in such a wireless network environment makes it much easier to adjust the coverage and bandwidth needs than design a network ahead of time. Adaptive routed mesh network make obstructions to the line-of-sight acquirements by growing trees of temporary obstructions less problematic, since the data traffic is automatically re-routed through as a link becomes unavailable. The nodes, i.e. wireless routers, in such an wireless routing network environment can adapt to changes in the link availability-and the quality in real-time without requiring intervention by a network administrator.

A network operating system continuously monitors the status and quality of the links and makes real-time routing decisions based on the current network status. New nodes can be authenticated and assimilated into the network topology without manual reconfigurations.

Hence, the coverage area of a wireless router network is constantly changing as new routers are installed. Since the routers' locations depend on customers' purchase decisions, pre-planning the network coverage area is not possible. Marketing wireless routers to consumers requires reliable information about the areas which are covered or which are going to be covered by the network in the near future. For currently covered areas the penetration should be increased. For new planned areas it is important to understand what amount and kind of population is covered with a planned router configuration and to attract new users to the technology.

So far, network planning and selection of marketing addresses have been selected by manually picking town sections. However, in wireless mesh networks, manual planning is not possible due to the fact that determination of line-of-sight and view is essential for the planning process. Cellular network planning tools consider propagation models but the proposed calculations are usually very rough. They have to be more detailed in mesh networks, since, compared to GSM planning, the link distances are very small, the number of routers per area are quite high, and the criteria is strict line-of-sight.

Thus, it is very important to know that a new node to be installed will be within the existing coverage area. However, there is actually no way to determine how the coverage will grow since it is a direct function of the customer layout as opposed to cellular networks where coverage holes are simply filled with new base stations or other means.

### SUMMARY OF THE INVENTION

It is therefore an object of the present invention to provide a method and system for improved network planning.

This object is achieved by a method of planning an expansion of a constantly changing wireless network, said method comprising the steps of:

storing node parameters of networks nodes of said wireless network in a database;

monitoring said wireless network by regularly reading node specific data stored at said network nodes;

constantly updating said database according to node changes determined in said monitoring step; and

dynamically calculating based on said constantly updated node parameters a combined coverage area achieved by said network nodes of said wireless network.

Additionally, the above object is achieved by a system for planning an expansion of a constantly changing wireless network, said system comprising:

a database for storing node parameters of networks nodes of said wireless network;

monitoring means for monitoring said wireless network by regularly reading node specific data stored at said network nodes;

updating means for constantly updating said database according to node changes determined by said monitoring means; and

coverage determination means for dynamically calculating based on said constantly updated node parameters a combined coverage area achieved by the network nodes of said wireless network.

Accordingly, the actual network coverage is available at any given point in time to plan network changes (e.g. Airhood split or the like), to understand how good the coverage is in a particular area, and to make marketing and business decisions. Thereby, a new approach of providing instant knowledge of network coverage at retailers is enabled to reduce deployment costs considerable due to individual installations.

The combined coverage area and/or customer purchase decisions may be used for deciding on an installation of a new network node, or for generating a customer address information. The node specific data may comprise the name, geographical data and link statistics of the respective one of the network nodes. In particular, the link statistics may comprise information of all possible links in the neighborhood of said respective one of said network nodes. The address information may be generated by using reverse geocoding. Thus, marketing or other business campaigns can be automated and targeted to so that only prospective customers who really can be connected are reached. This avoids a situation where the network operator has to reject orders from customers who have received an advertisement letter but are not located within the combined coverage area. Campaigns to increase penetration are easy to set up since the whole process of address generation and letter distribution can be fully automated.

Preferably, the node parameters comprise coordinates and/or performance data of said network nodes. Hence, location information and performance measurement data are combined to generate or visualize the network coverage area in an improved and reliable manner.

According to an advantageous development, the determination step may be based on a calculation of geographical points having a line of sight to at least one of said network nodes. The calculation may be a viewshed calculation differentiating different viewshed classes based on the visibility of other network nodes in each area.

According to another advantageous development, the further steps of determining a geographical area to be covered in the future, and selecting a target position for a new network node based on customer parameters and/or connection parameters may be performed. Thus, network service availability can be guaranteed in the future. Due to the unpredictable nature of customers joining the network, the planning process can be adapted to deviations from initial plans. Preferably, the customer parameters comprise a customer penetration within a one hop distance of said new network node, and the connection parameters comprise at least one of an access capability to an operator .network and/or a fixed network, an antenna installation height, and a transmission power level. Furthermore, node capacities may be determined based on the amount of network traffic, wherein a decision on the creation of a new network node or the movement of a customer to a neighbouring network node can be made if said determined node capacity exceeds a predetermined upper limit.

According to a further advantageous development, the frequency usage of said wireless network may be optimised so as to achieve minimum antenna installation heights and transmission powers.

Preferably, the combined coverage area is calculated as a polygon.

### BRIEF DESCRIPTION OF THE DRAWINGS

In the following, the present invention will be described in greater detail on the basis of a preferred embodiment with reference to the accompanying drawings, in which:

FIG. 1 shows a schematic representation of the nodes in a wireless network;

FIG. 2 shows a schematic block diagram of a wireless network planning system according to the preferred embodiment;

FIG. 3 shows an example of a city map with an indication of combined coverage areas;

FIG. 4 shows a diagram indicating operational and possible links and their quality;

FIG. 5 shows a resultant diagram of a viewshield calculation for a cumulative coverage area;

FIG. 6 shows a menu layout for indicating viewshed classes and deriving customer addresses; and

FIG. 7 shows a flow diagram of a network planning process according to the preferred embodiment.

### DESCRIPTION OF THE PREFERRED EMBODIMENT

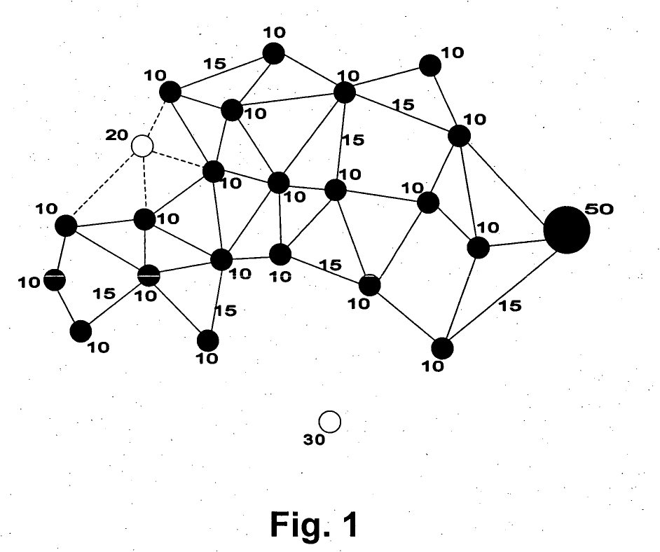

FIG. 1 shows a schematic representation of the wireless network with a plurality of network nodes 10. Each network node 10 is connected to neighbouring network nodes 10 via a multipoint-to-multipoint line-of-sight connection 15 by which the network nodes 10 communicate with each other. The wireless network comprise a Point-of-Presence POP 50 by which the wireless network is connected to the Internet or any other network. Into this wireless network with its existing network nodes 10 additional nodes 20, 30 are to be added.

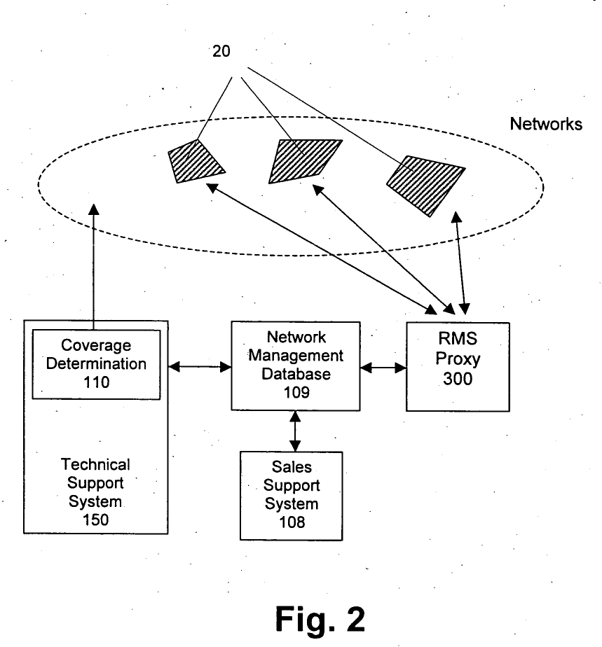

In FIG. 2, a wireless network management system is shown which is used for managing wireless routers as an example of the network nodes 10 in the network system of FIG. 1. A Router Management System Proxy (RMS Proxy) 300 is connected to a network management database 109, which is furthermore connected to a Sales Support System SSS 200 which may continuously be activated to ensure continuous availability. The SSS 200 may be connected to an input interface (not shown) for providing an access e.g. via the Internet or any other network. The SSS 200 is used among others as a direct customer interface for the direct communication with users and end-clients. The user or end-client can enter a street address where he wants to implement a new network node 20, 30. In addition to the street address the user can enter the height of the roof where the antenna of a desired network node, i.e. wireless router, can be arranged. Furthermore the search radius around the entered street address can also be inputted. The street address along with the height of the roof-top is forwarded to the SSS 200 e.g. via the Internet and can be stored in the network management database 109.

Furthermore, a Technical Support System (TSS) 150 is provided for connecting to the network management database 109 to access coordinate and performance data of the installed and/or planned wireless routers. Using the locations of the routers and some performance data (e.g. transmit power, antenna installation height or the like), a coverage determination functionality or unit 110 of the TSS 150 calculates the combined coverage area of the wireless routers. The calculation can be based on a concept of finding points having a line of sight to at least one of the other wireless routers. This concept may thus be a viewshed concept or any other suitable concept for determining a coverage of a wireless connection. In particular, the dynamical coverage area calculation may be based on a viewshed analysis of a three-dimensional map including building heights and statistical information about the existing network.

This coverage information can be used by the TSS 150 for the future planning and extension of the wireless network as well as for marketing or business purposes.

The information retrievable from the network management database 109 may consist for example of all or some of the following parts:

a) Line-of-sight to existing network nodes (wireless routers) within a high link speed coverage area;

b) line-of-sight to existing network nodes (wireless routers) within a low link speed coverage area;

c) line-of-sight to planned network nodes (routers);

d) planned coverage areas, i.e. detailed location of wireless routers which are missing for the time being but where network coverage is to be built;

e) line-of-sight sensitivity to antenna height (this information can be used to compensate for errors in map material like missing trees), tolerance in antenna location and estimated quality of the link;

f) likely antenna radiation directions as deduced from other links in the area (e.g. to compensate for antennas located on one side of the building);

g) availability of other technologies to connect the user (e.g. to create a fixed line connection if for some reason the wireless router connection against the calculated predictions cannot be created);

h) the capacity of the existing airhoods (i.e. cluster of subscriber routers in a neighbourhood, controlled by an Air Operating System, wherein the connections from the subscriber routers in the airhood to an Internet access point are organized via a single or multiple airheads)).

In the coverage determination unit 110, a combined network coverage of the wireless mesh network is calculated. This may be achieved by calculating geographical polygons 20 indicating geographical areas having a line-of-sight connection to at least one wireless router. The combined coverage areas 20 of the wireless network are constantly changing as new network nodes (e.g. wireless routers) are installed. Since the node locations depend on the customer's purchase decisions preplanning the network coverage area is not possible. Instead, it is important to be able to analyze what is the coverage at any given point in time to plan network changes, to understand how good is the coverage on a particular target area, and to make marketing and other business decisions.

Thus, using the calculated combined coverage areas. 20, it is possible to derive at any point in time the area currently covered by the wireless network. This is important for any network planning decisions which might concern network capacity, marketing, or business decisions.

The RMS Proxy 300 constantly or regularly monitors the network and updates the network management database 109 with new nodes and their coordinates. To achieve this, the RMS Proxy or management engine regularly or constantly reads node specific data stored in memories of the wireless routers 10. The node specific data is essential from the planning viewpoint, since it reflects the current network situation. In particular, the node specific data may comprise the name, geographical coordinates and link statistics of the respective wireless router. Thus, the actual cumulative coverage area can be calculated at any moment due to the fact that the network management database 109 is constantly updated based on any changes derived from the node specific data stored at the individual wireless routers. Consequently, the wireless routers 10 are at all times aware of all possible links to their neighbouring routers. Furthermore, information about poor links having a quality not sufficient to be utilized as links may be stored as well. Thus, even if only a view links are actually used for data processing, the wireless routers 10 know the characteristics of several possible links. This information (e.g. link statistics) is then stored by the RMS Proxy 300 in the network management database 109.

The underlying router management system is arranged to enable administrators to configure, monitor and upgrade the wireless network over-the-air, using e.g. a dynamic graphical user interface. Both simple tasks (e.g. assigning IP addresses) and more advanced network administration (e.g. authenticating network membership or managing network capacity) can thus be performed in a-quick and simple manner. In particular, the RMS Proxy 300 may continuously be activated and may comprise a polling engine for controlling the monitoring and updating activities.

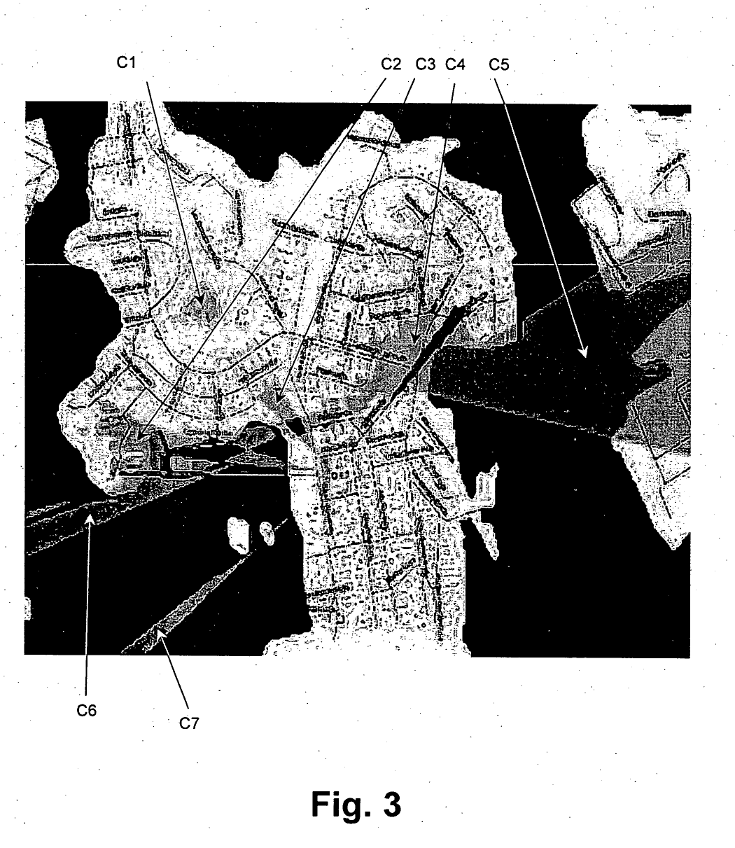

FIG. 3 shows an example of a calculated combined coverage areas C1 to C7 indicated as grey areas with different shades of grey in a city map of a city portion surrounded by water regions (dark areas). As can be gathered e.g. from the beam or coil shape of the coverage areas C2, C3, C5, C6 and C7, the determination of the coverage areas C1 to C7 is based on line-of-sight calculations. Thus, based on the determined coverage areas C1 to C7, the generation and judgement of locations for new wireless routers as well as customer addresses for advertisements may be determined.

Marketing wireless routers to consumers requires good understanding of the areas which are covered or which will be covered with the network. For currently covered areas the goal is to increase the penetration. For new planned areas it is important to understand how big and what kind of population is covered with a planned router configuration, and to attract new users to the technology. A key issue in planning e.g. a marketing campaign is selecting the right addresses for the marketing campaigns, so that only the prospective customers who really can be connected are reached. Thereby, a situation where the operator has to say no to a customer who has received an advertisement letter can be avoided. Moreover, campaigns to increase the penetration are easy to set up since the whole process of sending advertisement to the homes within the coverage areas C1 to C7 can be fully automated. Marketing data can also be used as an evaluation criteria for alternative network expansion scenarios.

Hence, using the coverage determination unit 110 of the TSS 150 and the dynamically changing data in the network management database 109, it is possible to calculate the coverage areas C1 to C7 and using e.g. reverse geocoding or other suitable location/address conversion schemes to generate addresses for direct marketing campaigns.

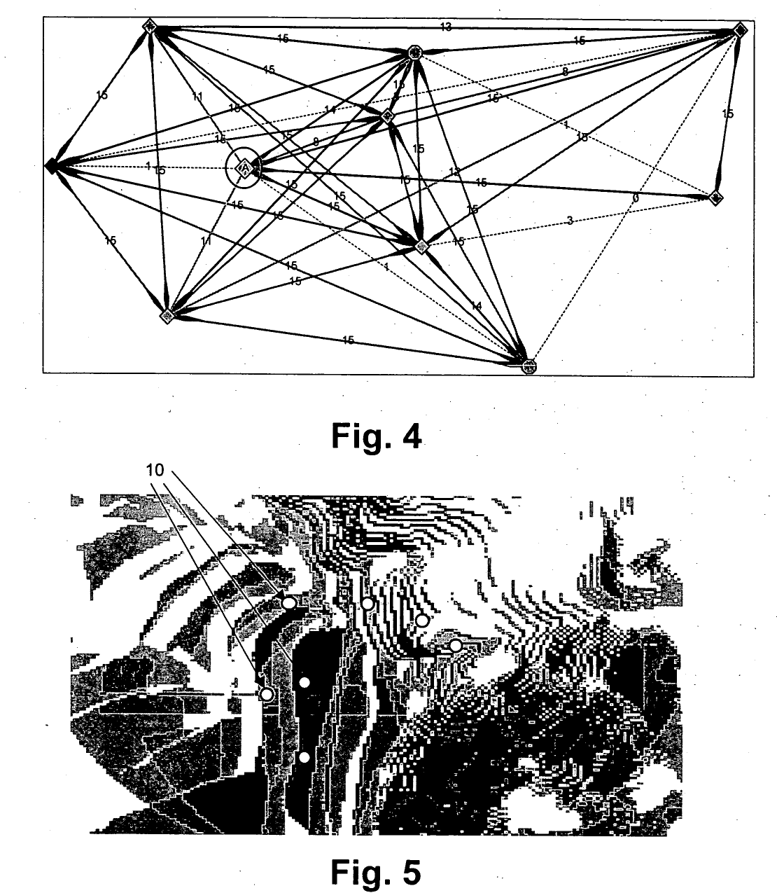

FIG. 4 shows a link diagram derived from the node specific link statistics and indicating available links at specific wireless routers comprising an airhead A (indicated by circle). The numbers added to the links indicated the quality of the links, wherein a higher number indicates a better quality. The black lines indicate operational user data links with high quality. The dark grey lines indicated possible links with good quality, while the light grey lines indicate possible links with fair quality. The dotted links indicate bad quality links due to no line of sight or too long distances.

The automatically measured information about possible links improves the accuracy of the coverage area. Line-of-sight calculation results based on map data and measured information about all available links each wireless router 10 can detect are combined automatically.

The calculation of the cumulated or combined coverage area can then be based on the viewshed concept and the link statistics. In this case, the geographical areas can be further differentiated by the number of neighbouring routers that can be accessed in each area.

FIG. 5 shows a diagram indicating a graphical result of such a viewshed calculation of a cumulative coverage area, wherein the greyscale or colour of individual coverage areas depends on the number of accessible or visible neighbouring wireless routers at each location on the map. E.g., a green coverage area may indicate a range of 1 to 3 accessible neighbouring routers, a yellow coverage area may indicate a range of 3 to 5 accessible neighbouring routers, and a blue coverage area may indicate a range of 6 or more accessible neighbouring routers. In FIG. 5, the corresponding wireless routers 10 are indicated as white dots. Of course, any other coding and/or colouring can be used for indicating such a link based coverage.

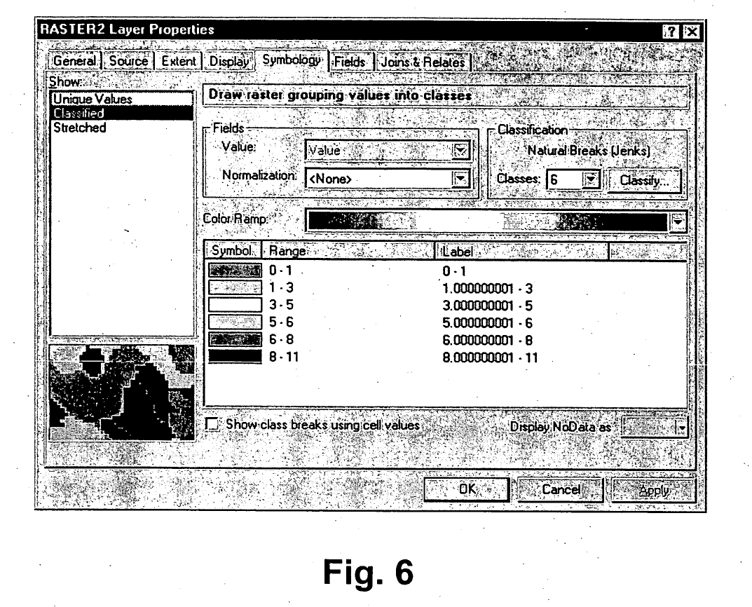

FIG. 6 indicates a menu layout for a man machine interface e.g. of the TSS 150, by means of which viewshed classes can be configured for obtaining and modifying a display as shown in FIG. 5. In particular, ranges and colours can selected and customer addresses within particular vieshed classes of the coverage area are also available from the system.

Due to the continuously changing network environment, consistency among plans in different phases and ability to use performance data collected from already implemented parts of the network is essential. For expansion planning all the existing network data must be always available. This process is essential as the network coverage is extended by each router in the network and as the routers are customer equipment there are continuous changes in the network. The following network planning process guarantees the network service availability.

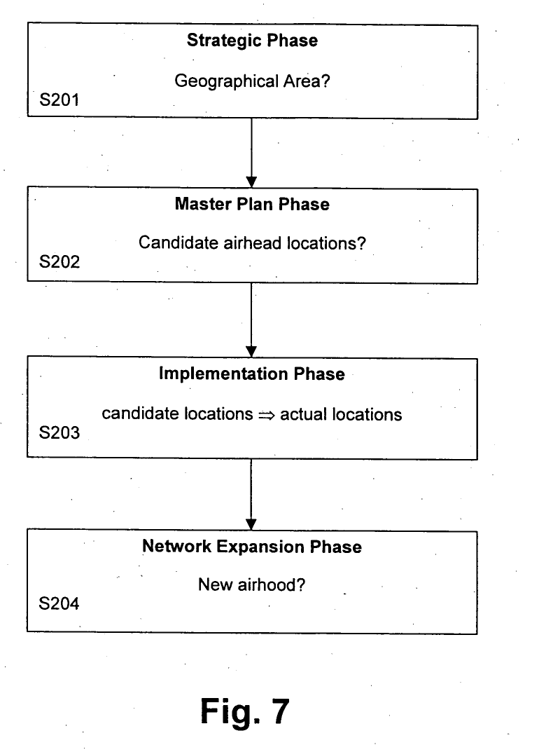

FIG. 7 shows a flow diagram of basic network planning phases S201 to S204 according to the preferred embodiment, which may be performed by the TSS 150 or another suitable planning support functionality of the network management system.

In an initial strategic phase S201, the key issue is determining which geographical area the network should cover next. The data of interested customers as collected by the SSS 108 and stored in the network management database 109 can be utilized. Moreover, data available for the TSS 150, e.g. demographics, building types, terrain form, can be used to support this task.

The key problem in a subsequent green-field planning phase or master plan phase S202 is to find the proper location for the airhead(s) (i.e. central aggregation routers in the wireless network, that connect subscriber routers in the neighbourhood mesh network to a high-speed uplink, or directly to an Internet access point). The target area of the network has to be determined (e.g. with the help of the customer data collected by the SSS 108). In the master plan phase S202, the target is to create basic coverage with few airheads and first subscriber routers. The airhead locations may be selected based on all or some of the following considerations:

a) it should be possible to connect the airhead to the operators network either with point-to-multipoint hop (i.e. line-of-sight connection to a multipoint basestation), Virtual LAN (Local Area Network) on optical fibers or with an ADSL (Asynchronous Digital Subscriber Line) line etc;

b) the maximum number of likely customers should be within one hop distance of the airhead;

c) the location should be “friendly” to the airhead (e.g. should provide internet access, no need for extra antenna);

d) antenna heights and transmission power levels should be planned based on penetration forecasts (i.e. in high penetration areas antennas are installed on lower level and lower TX power levels are assumed).

The calculations must typically be supplemented with field surveys. The outcome of the master plan phase S202 is a master plan.

In phase S202, possible airhead-locations may be derived by using the line-of-sight between a candidate location and the multipoint base station or, preferably, performing a viewshed calculation from the multipoint base station to determine feasible airhead locations. Furthermore, a list (import file) of ADSL termination points may be used.

Given addresses (e.g. known customers or addresses imported from SSS 108) should be covered by the new airhead. To achieve this, customer data are imported, analyzed as to how many are covered by using viewshed or pairwise line-of-sight calculations from the new airhead. Moreover, the location should be determined so as to cover as much of the desired target area as possible.

The coverage area can be calculate with different antenna heights to optimize the installation height of the airhood.

The network planning phases may be arranged to output specific directions important to be covered (e.g. to allow the antenna to be installed at the right side of a building) at an airhead location, nodeld, angle, distance, needed antenna height (similar to the information provided by the SSS 108) for each candidate subscriber, a list of candidate subscribers with only one connection (obtained e.g. by reverse geocoding).

Based on the planning concept, the polygons 20 can be created and continuously updated for existing and planned coverage areas.

In a subsequent implementation phase S203, the candidate locations that have been identified in the master plan phase S202 gradually become actual. As the actual locations depend on the buying behaviour of the consumers in the area, the actual locations are typically different from the planned ones. Therefore it is essential to use the up-to-date data that is collected from the network by the RMS proxy 300. The master plan gradually becomes an implementation plan which supports the mass roll-out.

In a final network expansion phase S204, it is determined, whether the number of users and the amount of traffic in an area increases the capacity of a serving or allocated airhood. If so, a decision is made as to whether some of the customers within an airhood need to be moved to neighbouring airhoods or a new airhood has to be created.

To reuse the transmission frequencies as efficiently as possible, a frequency band optimization step which may focus on having as low antennas and as low transmission power as possible could be initiated.

Thus, a unique new network solution which incorporates planning and administration features is provided. In other technologies, different parts have been planned with separate tools, which may cause inconsistency and requires resources, when the data from earlier phase or existing network is manually collected. Because of the unpredictable nature of customers joining the network, the process can adapt to deviations from the initial plans. Moreover, it is essential to get up-to-date snapshots of the network status at any point of time.

It should be noted that the present invention is not restricted to a network planning procedure for wireless routers, but can be used in any concept where an organic network growth has to managed effectively. Implementations of the invention in other systems are also possible, where combined coverage areas can be calculated. The preferred embodiment may thus vary within the scope of the attached claims.

1-17. (Cancelled).

18. A method of planning an expansion of a constantly changing wireless network, said method comprising the steps of:
a) storing node parameters of networks nodes of said wireless network in a database;
b) monitoring said wireless network by regularly reading node specific data stored at said network nodes;
c) constantly updating said database according to node changes determined in said monitoring step, said updating comprising updating new network nodes into said database; and
d) dynamically calculating based on said constantly updated node parameters a combined coverage area achieved by said network nodes of said wireless network, wherein said calculation is based on a concept of finding geographical points having a line-of-sight to at least one of said network nodes.

19. A method according to claim 18, further comprising the step of
using said combined coverage area and/or customer purchase decisions for deciding on an installation of a new network node.

20. A method according to claim 18, wherein said node specific data comprise the name, geographical data and link statistics of the respective one of said network nodes.

21. A method according to claim 20, wherein said link statistics comprise information of all possible links in the neighbourhood of said respective one of said network nodes.

22. A method according to claim 18, further comprising the step of
using said combined coverage area for generating a customer address information.

23. A method according to claim 22, wherein said address information is generated by using reverse geocoding.

24. A method according to claim 18, wherein said node parameters comprise coordinates and/or performance data of said network nodes.

25. A method according to claim 18, wherein said determination step is based on a calculation of geographical points having a line of sight to at least one of said network nodes.

26. A method according to claim 25, wherein said calculation is a viewshed calculation differentiating different viewshed classes based on the visibility of other network nodes in each area.

27. A method according to claim 18, further comprising the steps of determining a geographical area to be covered in the future, and selecting a target position for a new network node based on customer parameters and/or connection parameters.

28. A method according to claim 27, wherein said customer parameters comprise a customer penetration within a one hop distance of said new network node, and wherein said connection parameters comprise at least one of an access capability to an operator network and/or a fixed network, an antenna installation height, and a transmission power level.

29. A method according to claim 27, further comprising the steps of determining a node capacities based on the amount of network traffic, and deciding on the creation of a new network node or the movement of a customer to a neighbouring network node if said determined node capacity exceeds a predetermined upper limit.

30. A method according to 27, further comprising the step of optimising the frequency usage of said wireless network so as to achieve minimum antenna installation heights and transmission powers.

31. A method according to claim 18, wherein said combined coverage area is calculated as a polygon.

32. A system for planning an expansion of a constantly changing wireless network, said system comprising:
a) a database for storing node parameters of networks nodes of said wireless network;
b) monitoring means for monitoring said wireless network by regularly reading node specific data stored at said network nodes;
c) updating means for constantly updating said database according to node changes determined by said monitoring means, said updating comprising updating new network nodes into said database; and
d) coverage determination means for dynamically calculating based on said constantly updated node parameters a combined coverage area achieved by the network nodes of said wireless network, wherein said calculation is based on a concept of finding geographical points having a line-of-sight to at least one of said network nodes.

33. A system according to claim 32, wherein said network nodes comprise wireless routers.

34. A system according to claim 32, wherein said wireless network is a wireless mesh network.
